(19) United States
(12) Patent Application Publication
(10) Pub. No.: US 2019/0170009 A1
(43) Pub. Date: Jun. 6, 2019

(54) TURBINE ENGINE WITH CLEARANCE CONTROL SYSTEM

(71) Applicant: GENERAL ELECTRIC COMPANY, Schenectady, NY (US)

(72) Inventors: Arnab Sen, Bangalore (IN); Abhiram Kukunuri, Dudai (AE); Rajesh Kumar, Bangalore (IN); Sunil Manohar Gavaskar, Bangalore (IN)

(21) Appl. No.: 15/831,799

(22) Filed: Dec. 5, 2017

(51) Int. Cl. F01D 11/24; F01D 25/08

(52) U.S. Cl. CPC F01D 11/24; F01D 25/08; F05D 2220/323; F05D 2260/201; F05D 2240/14; F05D 2240/11; F05D 2260/213

(57) ABSTRACT

An apparatus and method for a clearance control system for a turbine engine comprising an annular casing having an exterior wall, a distribution manifold having at least one portion extending at least partially, circumferentially about the exterior wall, and at least one flow conduit for cooling or heating at least a portion of the annular casing.

### BACKGROUND OF THE INVENTION

Turbine engines are driven by a flow of combustion gases passing through the engine onto a multitude of rotating turbine blades. In some turbine engines, such as those used to propel aircraft, some aspects of engine performance depend upon clearances between turbine rotating blade tips and static shields or shrouds surrounding the blade tips.

A clearance control system can be configured to direct a cooling flow or a heating flow onto turbine casings to cause the casings to thermally expand or contract in order to increase or decrease a tip clearance.

### BRIEF DESCRIPTION OF THE INVENTION

In one aspect, the disclosure relates to a turbine engine comprising an annular casing having an exterior wall, a distribution manifold having at least one portion extending at least partially, circumferentially about the exterior wall, and at least one flow conduit extending at least partially, circumferentially within the exterior wall, and at least one connecting conduit fluidly connecting the distribution manifold to the flow conduit.

In another aspect, the disclosure relates to a clearance control system for a turbine engine, the clearance control system comprising an annular casing having an exterior wall, a distribution manifold having at least one portion extending at least partially, circumferentially about the exterior wall, and at least one flow conduit extending at least partially, circumferentially within the exterior wall, at least one connecting conduit fluidly connecting the distribution manifold to the flow conduit.

In yet another aspect, the disclosure relates to a method of distributing fluid within an annular casing for a turbine engine, the method comprising flowing the fluid through a distribution manifold at least partially circumscribing the annular casing, passing the fluid from the distribution manifold to a flow conduit within an exterior wall of the annular casing, and at least partially circumscribing the fluid about the annular casing to exchange heat between the annular casing and the fluid.

### BRIEF DESCRIPTION OF THE DRAWINGS

In the drawings:

FIG. 1 is a schematic view of a turbine engine assembly including a distribution manifold for a clearance control system.

FIG. 2 is partially cutaway perspective view of the distribution manifold according to an aspect of the disclosure discussed herein.

FIG. 3 is a schematic cross-section view of the distribution manifold from FIG. 2.

FIG. 4 is a partially cutaway enlarged view of the distribution manifold from FIG. 2.

FIG. 5 is an enlarged view of FIG. 4 only illustrating a method for using the distribution manifold from FIG. 2.

FIG. 6 is a flow chart diagram for the clearance control system of FIG. 1.

### DESCRIPTION OF EMBODIMENTS OF THE INVENTION

Aspects of the disclosure described herein are directed to a clearance control system having a distribution manifold in a turbine engine. Specifically, the clearance control system includes flow conduits within a casing for the turbine engine that are fluidly coupled to the distribution manifold for cooling and/or heating the casing. For purposes of illustration, the present disclosure will be described with respect to a turbine engine. It will be understood, however, that aspects of the disclosure described herein are not so limited and that a combustor as described herein can be implemented in engines, including but not limited to turbojet, turboprop, turboshaft, and turbofan engines. Aspects of the disclosure discussed herein can have general applicability within non-aircraft engines having a combustor, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the outlet of the engine or being relatively closer to the engine outlet as compared to another component. Additionally, as used herein, the terms “radial” or “radially” refer to a dimension extending between a center longitudinal axis of the engine and an outer engine circumference. Furthermore, as used herein, the term “set” or a “set” of elements can be any number of elements, including only one.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

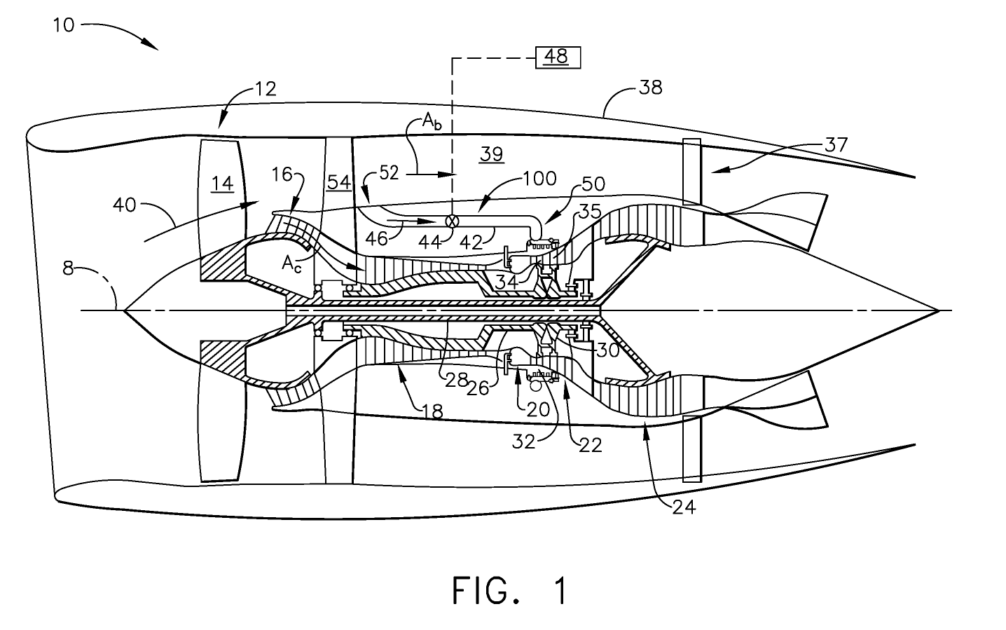

FIG. 1 is a schematic cross sectional view of a turbine engine 10 for an aircraft. The turbine engine 10 includes a clearance control system 100, according aspects of the disclosure discussed herein. Turbine engine 10 can include in a downstream serial flow relationship, a fan assembly 12 with a fan 14, a low pressure compressor 16, a high pressure compressor 18, a combustion section 20, a high pressure turbine 22, and a low pressure turbine 24. A high pressure shaft 26 can be disposed about an engine axis 8 and can drivingly connect the high pressure turbine 22 with the high pressure compressor 18. A low pressure shaft 28 can drivingly connect low pressure turbine 24 to low pressure compressor 16 and, in some cases also to the fan 14. High pressure turbine 22 can include a high pressure rotor 30, which can comprise a plurality of first stage turbine blades 34 and second stage turbine blades 35 mounted at a periphery of rotor 30. An annular casing 32 can circumscribe the turbine blades 34, 35.

An engine core 36 collectively includes the compressors 16,18, the combustion section 20, and the turbines 22, 24 and terminates in an exhaust 37. A nacelle 38 can circumscribe the engine core 36 to define a bypass duct 39 therebetween.

In operation, an airflow 40 flows through the fan assembly 12 and a core airflow (Ac) is channeled through compressors 16, 18 wherein the core airflow (Ac) is further compressed and delivered to the combustion section 20. Hot products of combustion (not shown) from the combustion section 20 are utilized to drive turbines 22, 24 and thus produce engine thrust. A bypass airflow (Ab) is discharged from fan assembly 12 and can flow through the bypass duct 39.

A supply conduit 42 can be disposed proximate the bypass duct 39 and can be coupled to a valve 44 for controlling an amount of thermal control fluid 46 within the supply conduit 42. The valve 44 can be controlled by a controller 48, such as a digital electronic engine control system often referred to as a full authority digital engine control (FADEC). Thermal control fluid 46 can be controllably flowed through the supply conduit 42 and supplied to the clearance control system 100 via a distribution manifold 50. The distribution manifold 50 can be used to cool or heat the annular casing 32.

By way of non-limiting example, the thermal control fluid 46 can be compressed core airflow (Ac) supplied via an air supply inlet 52 to the supply conduit 42. The air supply inlet 52 can be located downstream of exit guide vanes 54 disposed in the bypass duct 39 downstream of the fan 14. It should be appreciated that the term “fluid” as used herein includes any material or medium that flows, including, but not limited to, liquid, gas and air.

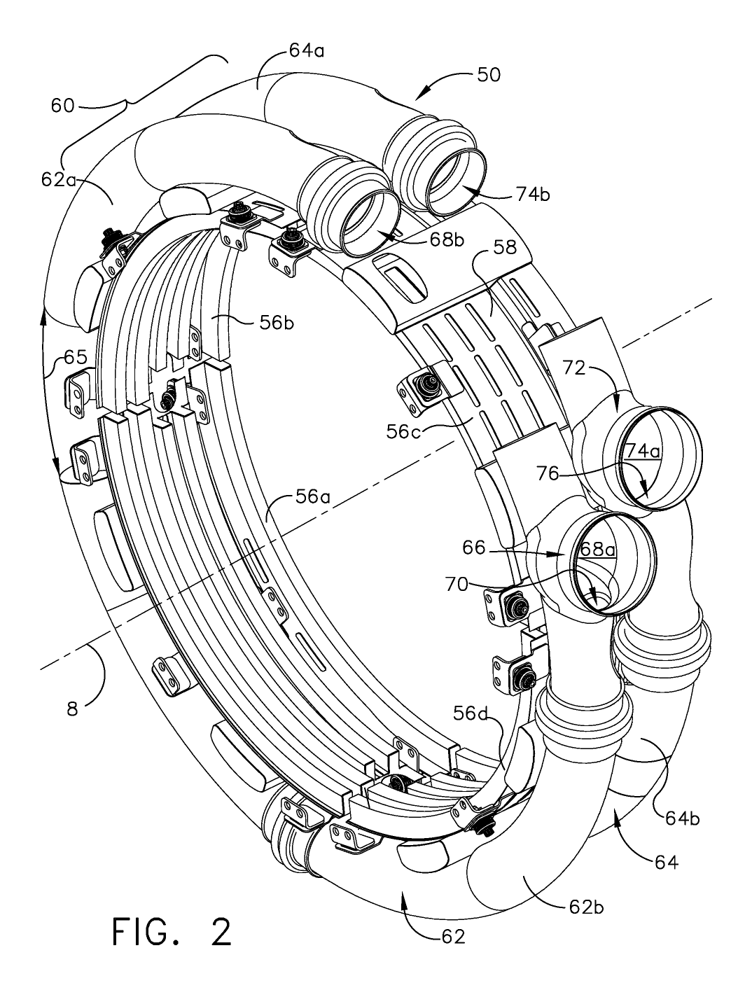

FIG. 2 is a partial cutaway perspective view of the distribution manifold 50 disposed circumferentially around the annular casing 32, according to at least some aspects of the disclosure described herein. The annular casing 32 can be formed from semicircular segments 56, by way of non-limiting example four semicircular segments 56a, 56b, 56c, 56d defining an exterior wall 58. It should be understood that the rounded segments can be shroud segments, or the like, and can form an annular casing for any portion of the engine, which by way of non-limiting example is the annular casing 32 for the high pressure turbine 22 as illustrated in FIG. 1.

The distribution manifold 50 can include at least one portion, illustrated as multiple discrete circumferential segmented portions 60, extending at least partially, circumferentially about the exterior wall 58. By way of non-limiting example the circumferential segmented portions 60 include a supply tube 62, illustrated as a first supply tube 62a and a second supply tube 62b. The circumferential segmented portions 60 further include a collection tube 64, illustrated as a first collection tube 64a and a second collection tube 64b are illustrated as disposed generally circumferentially around the annular casing 32. The supply tube 62 can be axially spaced from and next to the collection tube 64 as illustrated. The orientation and number of tubes is depicted for illustrative purposes only and not meant to be limiting.

The supply tube 62 and collection tube 64 can be constructed in the form of generally cylindrical tubing, which can form a generally toroidal shape about engine axis 8. In some aspects, the generally toroidal shape can be interrupted, such as by a gap 65 between downstream ends of first supply tube 62a and second supply tube 62b, which can be closed. The supply tube 62 and the collection tube 64 can comprise a generally tubular arc which forms part of the generally toroidal shape.

In aspects of the disclosure discussed herein the supply tube 62 can receive thermal control fluid 46 from supply conduit 42 via a tee 66. For example, tee 66 can comprise an inlet 68a fluidly coupled to supply conduit 42, and a lateral, generally circumferentially oriented outlet 70 fluidly coupled to second supply tube 62b. The supply tube 62 can receive thermal control fluid 46 from supply conduit 42 via inlet 68b as well. The manner in which the thermal control fluid 46 is received within the supply tube 62 can be in any suitable configuration.

In aspects of the disclosure discussed herein the collection tube 64 can exhaust thermal control fluid 46 via a tee 72. For example, tee 72 can comprise an outlet 74a fluidly coupled to the exhaust 37 and a lateral, generally circumferentially oriented inlet 76 fluidly coupled to second collection tube 64b. The collection tube 64 can exhaust thermal control fluid 46 into the exhaust 37 via outlet 74b as well. The manner in which the thermal control fluid 46 is exhausted can be in any suitable configuration.

It is further contemplated that the thermal fluid 46 is recycled. By way of non-limiting example the collection tube 64 and the supply tube 62 can be fluidly connected such that the thermal control fluid 46 can pass from one to the other.

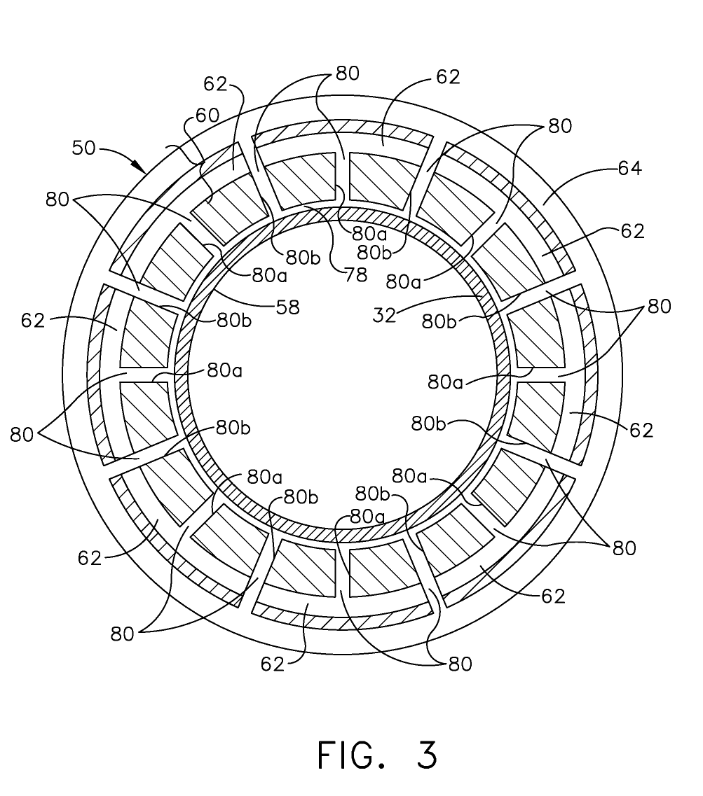

Turning to FIG. 3 a schematic cross-section of the distribution manifold 50 and annular casing 32 as described herein. The supply tube 62 is shown in circumferential segmented portions 60 for purposes of description only. While it is contemplated that the supply tube 62 can be in circumferential segmented portions 60, it is also contemplated that the supply tube 62 can extend circumferentially all the way around the annular casing 32. Collection tube 64 is illustrated as extending circumferentially all the way around the annular casing 32. It should be understood that collection tube 64 can be segmented as well.

At least one flow conduit 78 is disposed within the exterior wall 58 of the annular casing 32 and can also extend circumferentially all the way around the annular casing 32. It should be further understood that the flow conduit 78, like the supply and collection tubes 62, 64, can also extend partially circumferentially around the annular casing 32. A connecting conduit 80 can fluidly connect the distribution manifold 50 to the flow conduit 78 at any location along the exterior wall 58. More specifically, by way of non-limiting example, an inlet conduit 80a can be fluidly connected to the supply tube 62 and an outlet conduit 80b can be fluidly connected to the collection tube 64.

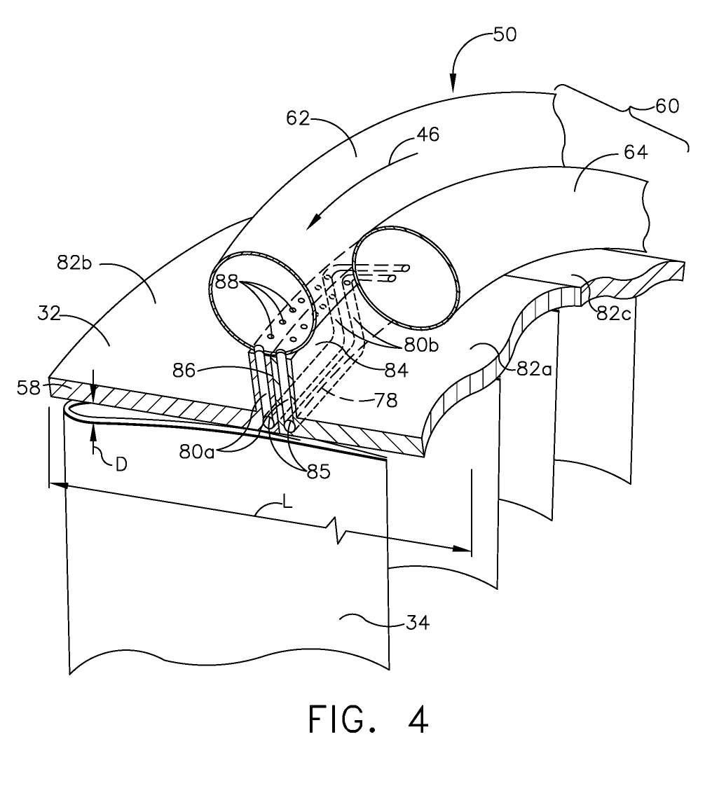

FIG. 4 illustrates an enlarged view of distribution manifold 50 according to at least some aspects of the disclosure discussed herein. It can more clearly be seen that the annular casing 32 can be formed from multiple segments 82a, 82b, 82c defining the exterior wall 58. Each multiple segment can terminate in a flange 84. The flange 84 can extend radially from the exterior wall 58 to define an annular confronting face 86. Each segment 82a can be coupled to the next consecutive segment 82b at opposing annular confronting faces 86 to further define an axial length (L) of the annular casing 32. While two confronting flanges 84 are illustrated for coupling two segments 82a, 82b, it should be appreciated that the segments 82a, 82b as illustrated can include multiple circumferentially distributed segments 82c. It should be further appreciated that the annular casing 32 can extend axially to varying lengths (L) such that multiple axially consecutive flanges define the annular casing 32.

The flow conduit 78 as discussed herein can be disposed in the exterior wall 58 radially within the flange 84. The flow conduit 78 can include at least one flow enhancer 85. The flow enhancer 85 can be a dimple, pin fin, or turbulator, or any other suitable flow enhancer 85 for increasing the heat exchange between the exterior wall 58 and the thermal control fluid 46. The flow conduit 78 can be separate segmented flow conduits 78 located parallel to each other as illustrated. It is further contemplated that the flow conduit 78 is staggered, a single flow conduit, segmented flow conduits, or the like.

The connecting conduits 80 as discussed herein can extend through the flange 84 and fluidly connect the flow conduit 78 to the supply tube 62 to define the inlet conduit 80a. The connecting conduit 80 can fluidly connect the flow conduit 78 to the collection tube 64 to define the outlet conduit 80b. The flow conduit 78 is fluidly connected to both the supply tube 62 via the inlet conduit 80a and the collection tube 64 via the outlet conduit 80b in any suitable configuration and is not limited to the description described herein.

The distribution manifold 50 can include multiple holes 88 disposed in one or both of the supply tube 62 and collection tube 64. The multiple holes 88 face the annular casing 32. In particular the multiple holes 88 are impingement holes facing the flange 84.

In operation, the annular casing 32 surrounds the turbine blades 34 as discussed herein and can define a clearance depth (D) therebetween. During take-off the clearance depth (D) will decrease, due to an increase in overall engine temperature, causing parts of the engine, including the rotor 30, turbine blades 34, and annular casing 32 to expand. A minimum clearance depth (D) is desirable for decreasing leakage and increasing overall efficiency of the engine.

The rotor 30, turbine blades 34, and annular casing 32 can expand at different rates. In the event the rotor 30 and turbine blades 34 expand more quickly than the annular casing 32, a blade out can occur, in which a part of the blade 34 hits the annular casing 32, which can result in damage to the blade 34 and/or annular casing 32. Actively heating the annular casing 32 during take-off can cause the annular casing 32 to expand at a faster rate than the rotor 30 and turbine blades 34 enabling control of the clearance depth (D). Maintaining the minimum clearance depth (D) provides maximum engine efficiency while minimizing or preventing blade out occurrences.

Once cruising, the overall engine temperature remains relatively constant. Once take-off is complete, any continued active heating of the annular casing would increase the clearance depth (D) too much causing inefficiencies. Actively cooling the annular casing 32 during cruising enables control of the clearance depth (D). Maintaining the minimum clearance depth (D) again maximizes engine efficiency while minimizing or preventing blade out occurrences. During operation, thermal control fluid 46 can be introduced to the supply tube 62 for heating or cooling the annular casing 32.

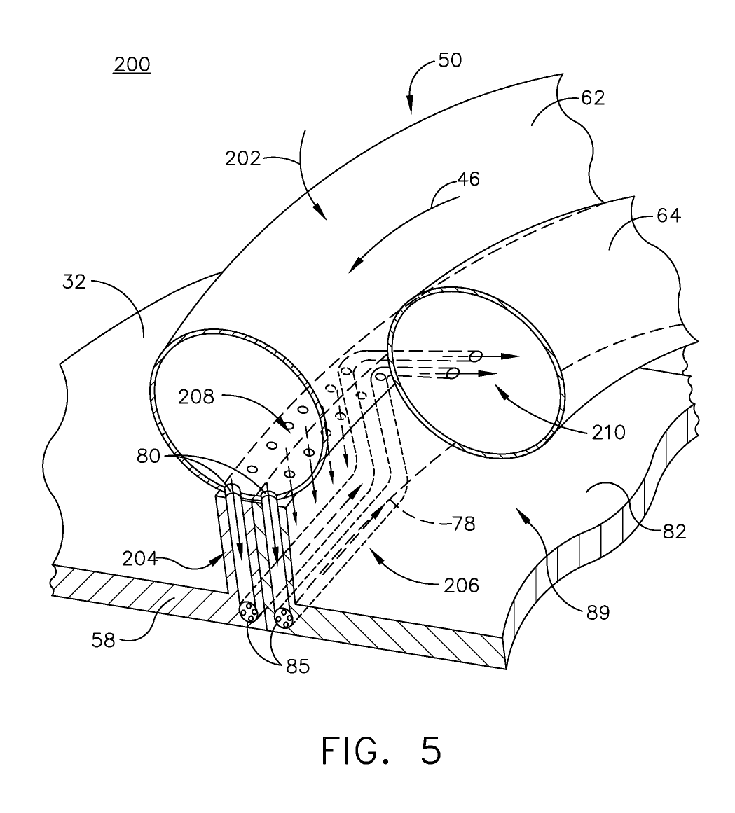

Turning to FIG. 5, a method 200 of distributing fluid within the annular casing 32 is illustrated. FIG. 5 is an enlarged version of FIG. 4, with some numbers from FIG. 4 removed for clarity. The method 200 includes as indicated by arrow 202, flowing fluid, by way of non-limiting example the thermal control fluid 46, through the distribution manifold 50 at least partially circumscribing the annular casing 32. The thermal control fluid 46 is then passed, as indicated by arrow 204, from the distribution manifold 50 to the flow conduit 78 within the exterior wall 58 of the annular casing 32. The thermal control fluid 46 can be passed through the connecting conduit 80, by way of non-limiting example the inlet conduit 80a, located in the flange 84 to enter the flow conduit 78. The thermal control fluid 46 can then at least partially circumscribe the annular casing 32, as indicated by arrow 206, to exchange heat between the annular casing 32 and the thermal control fluid 46.

It is further contemplated that the thermal control fluid 46 can be impinged, as indicated by arrow 208, onto a portion of the annular casing 32, by way of non-limiting example the flange 84 through the multiple holes 88 located in the distribution manifold 50 to further exchange heat between the thermal control fluid 46 and the annular casing 32. The thermal control fluid 46 can exit, as indicated by arrow 210, via the connecting conduit 80, by way of non-limiting example the outlet conduit 80b, to the collection tube 64. The thermal control fluid 46 can be recycled back through the supply conduit 62 after being heated or cooled, depending on a stage of operation, for example take-off or cruise as described herein, in which the engine 10 is operating. In this manner, the distribution manifold 50, the at least one flow conduit 78, and the connecting conduit 80 are part of a closed system 89. It is further contemplated that the thermal control fluid 46 is exhausted via the exhaust 37.

The exchange of heat between the thermal control fluid 46 and the annular casing 32 can result in heating the annular casing 32. By way of non-limiting example the heating of the annular casing 32 can occur during take-off as described herein. It is also contemplated that the exchange of heat between the fluid and the annular casing can result in cooling the annular casing 32. By way of non-limiting example the cooling of the annular casing can occur during take-off as described herein.

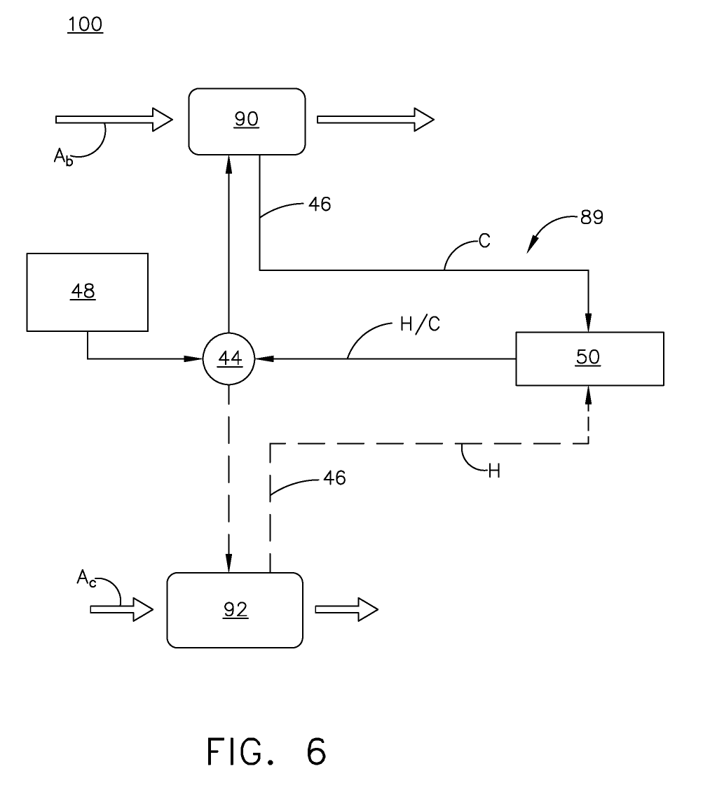

FIG. 6 is a flow chart for the clearance control system 100 that utilizes the distribution manifold 50 as described herein. Bypass airflow (Ab) can pass through a heat exchanger 90, which can be a fan stream heat exchanger or surface cooler, oil or fuel heat exchanger, or other dedicated bus fluid cooling system. By way of non-limiting example the heat exchanger 90 can be proximate the exit guide vane 54 downstream of the fan assembly 12 in FIG. 1. Thermal control fluid 46, which can be by way of non-limiting example the bypass airflow (Ab) or a liquid fluid cooled by the bypass airflow (Ab), is then introduced to the distribution manifold 50 as a cooling fluid (C) to cool the annular casing 32 during a stage of operation where cooling is necessary as discussed herein. The cooling fluid (C) can be returned via a valve 44 to the heat exchanger 90. It should be understood that cooling fluid (C) will be warmed within the distribution manifold 50 and is returned as heated fluid (H).

It is contemplated that the heated fluid (H) can pass through a second heat exchanger 92, by way of non-limiting example a waste heat recovery, system air pre-cooler, oil or fuel heat exchanger, or other dedicated bus fluid heating system. By way of non-limiting example the heat exchanger 92 is located proximate the engine exhaust 37 downstream with respect to the core airflow (Ac) in the low pressure turbine 24 in FIG. 1. Thermal control fluid 46, which can be by way of non-limiting example the core airflow (Ac) or a fluid heated by the core airflow (Ac), is then introduced to the distribution manifold 50 as a heating fluid (H) to heat the annular casing 32 during a stage of operation where heating is necessary as discussed herein. The heating fluid (H) can be returned via a valve 44 to the heat exchanger 92. It should be understood that heating fluid (H) will be cooled within the distribution manifold 50 and is returned as cooled fluid (C).

Benefits associated with the disclosure as discussed herein include heating/cooling the annular casing from within an exterior wall of the annular casing. Specifically the thermal control fluid can flow directly through the casing all the way to the root of the flange resulting in better clearance control. Controlling the clearance gap between the casing and the blades is important for engine performance. Minimizing the clearance is the best for performance, and controlling for any rubbing between the blade and the annular casing is also important for optimal performance of the turbine engine. Controlling the clearance during take-off and cruise improves the specific fuel capacity of the engine.

To the extent not already described, the different features and structures of the various aspects of the disclosure as described herein can be used in combination with each other as desired. That one feature is not illustrated in all of the exemplary illustrations is not meant to be construed that it cannot be, but is done for brevity of description. Thus, the various features of the different aspects of the disclosure as discussed herein can be mixed and matched as desired to form new aspects, whether or not the new aspects are expressly described. All combinations or permutations of features described herein are covered by this disclosure.

It should be appreciated that application of the disclosed design is not limited to turbine engines with fan and booster sections, but is applicable to turbojets and turbo engines as well.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A turbine engine comprising:
an annular casing having an exterior wall;
a distribution manifold having at least one portion extending at least partially, circumferentially about the exterior wall; and
at least one flow conduit extending at least partially, circumferentially about the exterior wall; and
at least one connecting conduit fluidly connecting the distribution manifold to the flow conduit.

2. The turbine engine of claim 1 wherein the distribution manifold comprises multiple discrete circumferential segments.

3. The turbine engine of claim 1 wherein the distribution manifold extends all the way around the annular casing.

4. The turbine engine of claim 1 wherein the distribution manifold comprises a supply tube and a collection tube.

5. The turbine engine of claim 4 wherein the connecting conduit comprises at least one inlet conduit and at least one outlet conduit.

6. The turbine engine of claim 5 wherein the at least one inlet conduit is coupled to the supply tube and the at least one outlet conduit is coupled to the collection tube.

7. The turbine engine of claim 1 wherein the at least one flow conduits extends circumferentially all the way around and within the annular casing.

8. The turbine engine of claim 1 wherein the annular casing comprises multiple segments each having a flange at which each consecutive segment is connected.

9. The turbine engine of claim 5 wherein the at least one flow conduit is provided radially within the flange.

10. The turbine engine of claim 6 wherein the at least one connecting conduit extends radially between the distribution manifold and flow conduit within the flange.

11. The turbine engine of claim 1 wherein the distribution manifold comprises multiple holes facing the annular casing and the holes are impingement holes for impingement cooling or heating.

12. The turbine engine of claim 1 wherein the distribution manifold, the at least one flow conduit, and the connecting conduit are part of a closed system.

13. The turbine engine of claim 1 wherein the at least one flow conduit includes at least one flow enhancer.

14. The turbine engine of claim 1 further including a heat exchanger selectively coupled to the distribution manifold via a valve.

15. A clearance control system for a turbine engine, the clearance control system comprising:
an annular casing having an exterior wall;
a distribution manifold having at least one portion extending at least partially, circumferentially about the exterior wall; and
at least one flow conduit extending at least partially, circumferentially about the exterior wall;
at least one connecting conduit fluidly connecting the distribution manifold to the flow conduit.

16. The clearance control system of claim 15 wherein the distribution manifold comprises a supply tube and a collection tube.

17. The clearance control system of claim 15 wherein the connecting conduit comprises at least one inlet conduit and at least one outlet conduit.

18. The clearance control system of claim 15 wherein the annular casing comprises multiple segments each having a flange and the at least one flow conduit is provided radially within the flange.

19. The clearance control system of claim 15 wherein the distribution manifold comprises multiple holes facing the annular casing and the holes are impingement holes for impingement cooling or heating.

20. The clearance control system of claim 15 further including a heat exchanger selectively coupled to the distribution manifold via a valve.

21. A method of distributing fluid within an annular casing for a turbine engine, the method comprising:
flowing the fluid through a distribution manifold at least partially circumscribing the annular casing;
passing the fluid from the distribution manifold to a flow conduit within an exterior wall of the annular casing; and
at least partially circumscribing the fluid about the annular casing to exchange heat between the annular casing and the fluid.

22. The method of claim 21 further comprising impinging the fluid onto a portion of the annular casing through multiple holes located in the distribution manifold.

23. The method of claim 21 wherein the passing the fluid further comprises flowing the fluid through a connecting conduit located in a flange extending from the annular casing.

24. The method of claim 21 further comprising heating the annular casing.

25. The method of claim 21 further comprising cooling the annular casing.
